(19) United States
(12) Patent Application Publication
(10) Pub. No.: US 2024/0066864 A1
(43) Pub. Date: Feb. 29, 2024

(54) Device and Method for Producing Pre-Fire Pulses

(71) Applicant: Canon Production Printing Holding B.V., Venlo (NL)

(72) Inventors: Markus Keller, Schrobenhausen (DE); Christoph Rummelsberger, Ismaning (DE); Martin Wilhelm, Maitenbeth (DE); Timo Sponer, Markt Schwaben (DE)

(21) Appl. No.: 18/237,495

(22) Filed: Aug. 24, 2023

(30) Foreign Application Priority Data
Aug. 25, 2022 (DE) 10 2022 121 535.0

(51) Int. Cl. B41J 2/045

(52) U.S. Cl. CPC B41J 2/04598; B41J 2/04573

(57) ABSTRACT

Provided is a device for controlling the printing of a print image with a nozzle of an inkjet printing device. The device is configured to—given the presence of a relatively long printing pause of the nozzle insert one or more print image-independent pre-ejection pulse phases, followed by a print image-dependent pre-ejection pulse phase, between the printing of two successive dots, in order to efficiently and reliably increase the print quality of the printing device.

### CROSS-REFERENCE TO RELATED APPLICATION

This application claims priority to German Patent Application No. 10 2022 121 535.0 filed Aug. 25, 2022, the disclosure of which is hereby incorporated by reference in its entirety.

### BACKGROUND OF THE INVENTION

### Field of the Invention

The invention relates to a device and a corresponding method for increasing the print quality of an inkjet printing device by inserting one or more pre-fire pulses.

### Description of Related Art

Inkjet printing devices may be used for printing to recording media, for example paper. For this purpose, one or more nozzles are used in order to fire ink droplets onto the recording medium, and thus in order to generate a desired print image on the recording medium.

If it is intermittently unused, a nozzle of an inkjet printing device can become functionally impaired, or possibly dry up, depending on the characteristic of the ink in use, on the ambient climate, on the print image etc. This may lead to a reduced print quality or to errors in the print image.

### SUMMARY OF THE INVENTION

The present document deals with the technical object of lastingly increasing the print quality of an inkjet printing device. The object is respectively achieved via the features discussed hereinafter.

According to one aspect, a method is described for inserting one or more pre-ejection pulses, i.e. one or more pre-fire pulses, into the printing of a print image by means of at least one nozzle of an inkjet printing device. The method comprises the determination of an interval, for example a time and/or line interval, until the printing of a subsequent dot by means of the nozzle. Furthermore, the method comprises effecting a print image-dependent pre-ejection pulse phase by means of the nozzle if the interval is less than or equal to a predefined interval threshold. One or more parameters of the print image-dependent pre-ejection pulse phase can thereby be dependent on the determined interval, in particular on the value of the interval.

The method also comprises effecting a—if applicable, at least one—print image-independent pre-ejection pulse phase by means of the nozzle if the interval is greater than the predefined interval threshold. The one or more corresponding parameters of the print image-independent pre-ejection pulse phase can thereby be independent of the determined interval, in particular independent of the value of the interval.

According to a further aspect, a device is described for controlling the printing of a print image by means of at least one nozzle of an inkjet printing device. The device is configured to determine the interval until the printing of a subsequent dot by means of the nozzle. Furthermore, the device is configured to effect a print image-dependent pre-ejection pulse phase by means of the nozzle if the interval is less than or equal to a predefined interval threshold. The device is also configured to effect a print image-independent pre-fire pulse phase by means of the nozzle if the interval is greater than the predefined interval threshold.

### BRIEF DESCRIPTION OF THE DRAWINGS

The terms FIG., FIGS., Figure, and Figures are used interchangeably in the specification to refer to the corresponding figures in the drawings.

In the following, exemplary embodiments of the invention are described in detail using a schematic drawing. Thereby shown are:

FIG. 1 a block diagram of an example of an inkjet printing device;

FIG. 2 a schematic design of a nozzle;

FIG. 3a examples of print image-dependent pre-fire pulse phases;

FIG. 3b examples of cyclical and print image-dependent pre-fire pulse phases; and

FIG. 4 a workflow diagram of an example of a method for inserting pre-fire pulses.

### DESCRIPTION OF THE INVENTION

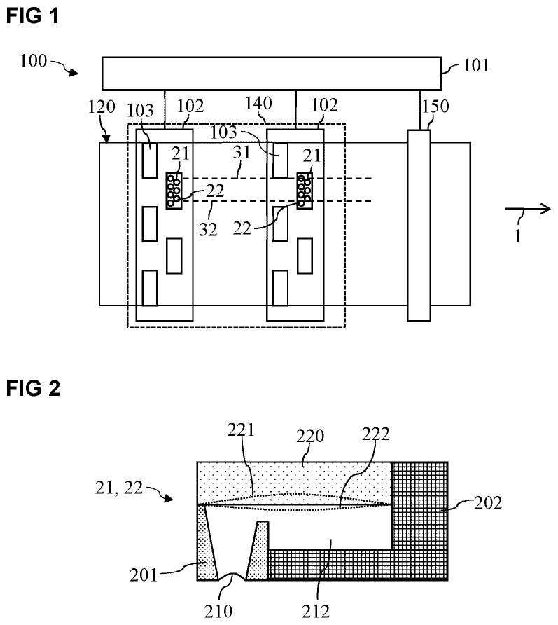

The printing device 100 depicted in FIG. 1 is designed for printing to a recording medium 120 in the form of a sheet or page or plate or belt. The recording medium 120 can be produced from paper, paperboard, cardboard, metal, plastic, textiles, a combination thereof, and/or other materials that are suitable and can be printed to. The recording medium 120 is guided along the transport direction 1, represented by an arrow, through the print group 140 of the printing device 100.

In the depicted example, the print group 140 of the printing device 100 comprises two print bars 102, wherein each print bar 102 can be used for printing with ink of a defined color, for example black, cyan, magenta, and/or yellow, and MICR ink if applicable. Different print bars 102 can be used for printing with respective different inks. Furthermore, the printing device 100 comprises at least one fixing or drying unit 150 that is configured to fix a print image printed onto the recording medium 120.

A print bar 102 can comprise one or more print heads 103 that, if applicable, are arranged in a plurality of rows side-by-side in order to print the dots of different columns 31, 32 of a print image onto the recording medium 120. In the example depicted in FIG. 1, a print bar 102 comprises five print heads 103, wherein each print head 103 prints the dots of a group of columns 31, 32 of a print image onto the recording medium 120.

In the embodiment illustrated in FIG. 1, each print head 103 comprises a plurality of nozzles 21, 22, wherein each nozzle 21, 22 is configured to fire or eject ink droplets onto the recording medium 120. For example, a print head 103 of the print group 140 can comprise multiple thousands of effectively utilized nozzles 21, 22 that are arranged along a plurality of rows transverse to the transport direction 1 of the recording medium 120. Dots of a line of a print image can be printed onto the recording medium 12 transverse to the transport direction 1, i.e. along the width of the recording medium 120, by means of the nozzles 21, 22 of a print head 103 of the print group 140.

The printing device 100 also comprises a control unit or control device 101, for example a driver hardware and/or a controller, that is configured to drive actuators of the individual nozzles 21, 22 of the individual print heads 103 of the print group 140 in order to apply the print image onto the recording medium 120 depending on print data.

The print group 140 of the printing device 100 thus comprises at least one print bar 102 having K nozzles 21, 22 that can be activated with a defined line timing in order to print a line, said line traveling transverse to the transport direction 1 of the recording medium 120, with K pixels or K columns 31, 32 of a print image onto the recording medium 120, for example with K>1000. In the depicted example, the nozzles 21, 22 are installed so as to be immobile or fixed in the printing device 100, and the recording medium 120 is directed past the stationary nozzles 21, 22 with a defined transport velocity.

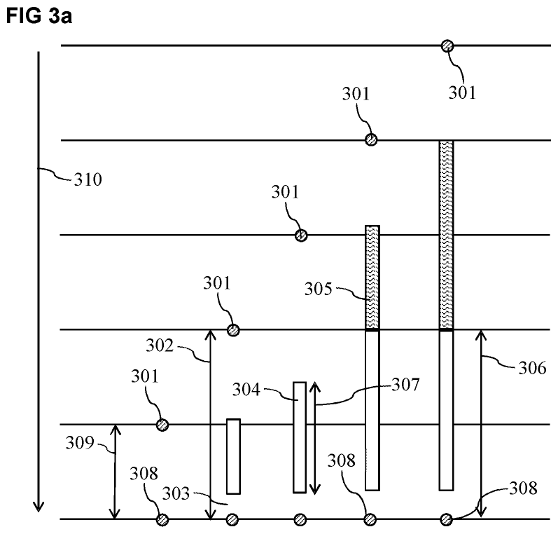

FIG. 2 shows an example of a design of a nozzle 21, 22 of a print head 103. The nozzle 21, 22 comprises walls 202 which, together with an actuator 220 and a nozzle opening 201, form a container or a chamber 212 to accommodate ink. An ink droplet can be fired or ejected onto the recording medium 120 via the nozzle opening 201 of the nozzle 21, 22. The ink forms what is known as a meniscus 210 at the nozzle opening 201. The actuator 220—for example a piezoelectric element—of the nozzle 21, 22 is configured to vary the volume of the chamber 212 for accommodating the ink, or to vary the pressure in the chamber 212 of the nozzle 21, 22. In particular, the volume of the chamber 212 can be reduced by the actuator 220 as a result of a deflection 222, and thus the pressure in the chamber 212 can be increased. An ink droplet can thus be ejected from the nozzle 21, 22 via the nozzle opening 201. FIG. 2 shows a corresponding deflection 222 of the actuator 220. Moreover, the volume of the chamber 212 can be increased by the actuator 220 (see deflection 221) in order to draw new ink into the chamber 212 via an inlet (not shown in FIG. 2).

Via a deflection 221, 222 of the actuator 220, the ink within the nozzle 21, 22 can thus be moved and the chamber 212 can be placed under pressure. A defined movement of the actuator 220 thereby effects a corresponding defined movement of the ink or of the meniscus 210. The defined movement of the actuator 220 is typically effected via a correspondingly defined waveform or a correspondingly defined pulse of an activation signal of the actuator 220. In particular, via a fire pulse —which is also referred to as an ejection pulse—to drive the actuator 220 it can be effected that the nozzle 21, 22 ejects an ink droplet via the nozzle opening 201. Different ink droplets can be ejected via different activation signals or ejection pulses at the actuator 220. In particular, ink droplets with different droplet size (for example 5 pl, 7 pl, or 12 pl) can be ejected via different ejection pulses. Furthermore, via a pre-fire pulse—which is also referred to as a pre-ejection pulse—to activate the actuator 220 it can be effected that, although the nozzle 21, 22 effects a movement of the ink and/or an oscillation of the meniscus 210, no ink droplet is ejected via the nozzle opening 201.

If a nozzle 21, 22 is not activated to effect an ink ejection for a relatively long period of time, this may lead to the viscosity of the ink at the meniscus 210 of the nozzle 21, 22 increasing, whereby a subsequent ink ejection, and therewith the print quality of the printing device 100, can be negatively affected. Pre-ejection pulses can be used to decrease the viscosity of the ink at the meniscus 210 of a nozzle 21, 22 in preparation for an ink ejection, in order to mix the ink at the meniscus with the ink in the chamber 212. The print quality is increased as a result of this. The present document describes a method that enables a flexible, efficient, and optimized usage of pre-ejection pulses, in particular given the use of a relatively fast-drying ink, in order to increase the print quality of a printing device 100.

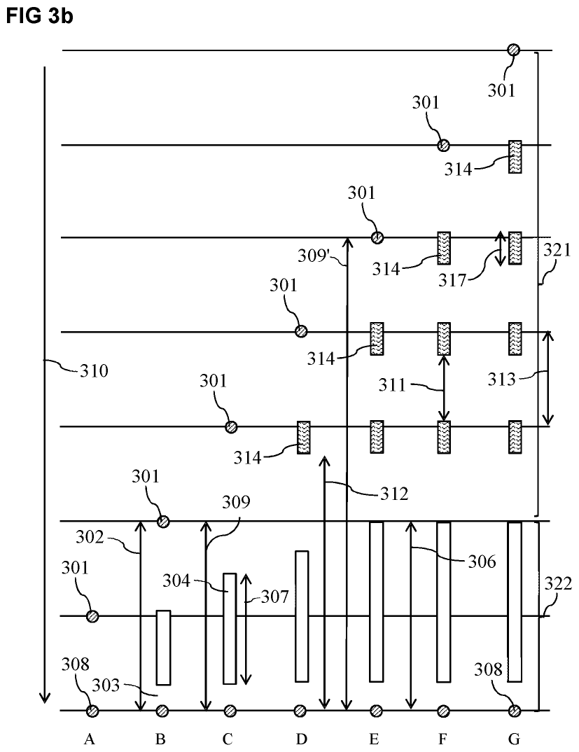

FIG. 3a illustrates the possibility of inserting pre-ejection pulses between successive ejection pulses in order to prevent ink in a nozzle 21, 22 from drying up. FIG. 3a shows successive dots 301, 308 that are printed by a defined nozzle 21, 22, wherein the time and/or line intervals 309, 309′ between the successive dots 301, 308 differ from one another. The arrow depicted in FIG. 3a illustrates the printing direction 310 of the printing device 100. Respective directly successive dots 301, 308 that are spaced apart from one another at different distances are also depicted in the different columns of FIG. 3a, wherein the interval 309, 309′ between the respective successive dots 301, 308 increases from left to right.

The (control) device 101 can be configured to determine the interval 309, 309′ between two directly successive dots 301, 308 on the basis of the image data for the print image to be printed. On the basis of the determined interval 309, 309′, it can then be determined whether a pre-ejection pulse phase 304 is inserted between the two dots 301, 308, in which pre-ejection pulse phase 304 one or more pre-ejection pulses are effected in order to prevent a drying up of the ink in the respective nozzle 21, 22. The device 101 can in particular be configured to compare the determined interval 309, 309′ with a predefined first interval threshold 302. If the determined interval 309 is less than the first interval threshold 302, if applicable it can be dictated that no pre-ejection pulse phase 304 is inserted. On the other hand, if the determined interval 309, 309′ is greater than or equal to the first interval threshold 302, it can thus be dictated that a pre-ejection pulse phase 304 is inserted.

A pre-ejection pulse phase 304 is preferably inserted between the ejection pulses for the directly successive dots 301, 308 such that a rest phase 303 is arranged directly before the ejection pulses for the following dot 308, in which rest phase 303 no pre-ejection pulses are effected in order to effect a resting of the meniscus 210 of the nozzle 21, 22. A negative effect on the print quality of the subsequent dot 308 due to one or more pre-ejection pulses of the pre-ejection pulse phase 304 can thus be avoided.

The pre-ejection pulse phase 304 can depend on the time and/or line interval 309, 309′ between the directly successive dots 301, 308, in particular with regard to one or more parameters of the pre-ejection pulse phase 304. Examples of parameters are:
the duration 307 of the pre-ejection pulse phase 304; and/or
the number of pre-ejection pulses within the pre-ejection pulse phase 304.

The (control) device 101 can be configured to adjust one or more parameters of the inserted pre-ejection pulse phase 304 depending on the determined interval 309, 309′ between the directly successive dots 301, 308. The duration 307 of the pre-ejection pulse phase 304 and/or the number of pre-ejection pulses within the pre-ejection pulse phase 304 can thereby be increased with increasing interval 309, 309′ or be reduced with decreasing interval 309, 309′. The inserted pre-ejection pulse phase 304 can thus depend on the print image that is to be printed by the printing device 100. The pre-ejection pulse phase 304 can therefore also be referred to as a print image-dependent pre-ejection pulse phase 304.

A printing device 100 typically has a maximum possible preview with regard to the print data to be printed, which preview can, for example, be predetermined by the size of a buffer storage. For example, the preview can be limited to a defined number of pending print lines of the print image to be printed. Alternatively or additionally, for technical reasons the duration 307 of the pre-ejection pulse phase 304 can be limited to a maximum possible duration 306, if applicable inclusive of the duration of the required rest phase 303.

Given a relatively large interval 309′ between two directly successive dots 301, 308, one or more limitations, in particular hardware limitations, of the printing device 100 can thus lead to the inserted pre-ejection pulse phase 304 being insufficient in order to avoid a drying out of the ink and/or a negative effect on the nozzle 21, 22. The missing portion 305 of the actual required pre-ejection pulse phase 304 is respectively represented in FIG. 3a by a bar with a wavy dashed-line fill.

As is depicted by way of example in FIG. 3b, the (control) device 101 can be configured to determine that the interval 309′ between two directly successive dots 301, 308 whose precise value possibly cannot be determined is greater than a second interval threshold 312 (instances D through G in FIG. 3b). The second interval threshold 312 is thereby preferably greater than the first interval threshold 302, and possibly greater than the maximum possible duration 306 of the print image-dependent pre-ejection pulse phase 304.

In reaction to the determination, it can then be effected that a pre-ejection pulse phase 314 is inserted, wherein the inserted pre-ejection pulse phase 314 can extend beyond a defined phase duration 317. The one or more parameters of the pre-ejection pulse phase 314—for example the phase duration 317 and/or the number of pre-ejection pulses within the pre-ejection pulse phase 314—are preferably independent of the print image to be printed. This pre-ejection pulse phase 314 can therefore also be referred to as a print image-independent pre-ejection pulse phase. This pre-ejection pulse phase 314 can preferably occur after the second interval threshold.

The (control) device 101 can be configured to check, with a defined repetition rate, whether the interval 309′ between two directly successive dots 301, 309 continues to be greater than the second interval threshold 312. If this is so, a print image-independent pre-ejection pulse phase 314 can be inserted again. Print image-independent pre-ejection pulse phase 314 can be accordingly inserted with the defined repetition rate, in particular cyclically, such that these pre-ejection pulse phases 314 can also be referred to as cyclical pre-ejection pulse phases. Via the insertion of one or more cyclical and/or print image-independent pre-ejection pulse phases 314, it can be efficiently and reliably effected that a drying up of ink is avoided even given a relatively large interval 309′ between two directly adjacent dots 301, 308 whose values possibly cannot be determined by the device 101.

On the other hand, if it is detected at a checkpoint in time and/or in a check line of the print image that the interval 309, whose precise value can possibly be determined on the basis of the print data, is less than or equal to the second interval threshold 312, a print image-dependent pre-ejection pulse phase 304 can be inserted instead of a cyclical and/or print image-independent pre-ejection pulse phase 314 (instances A through B in FIG. 3b). One or more parameters of the inserted print image-dependent pre-ejection pulse phase 304 can also be established on the basis of the determined interval 309.

The (control) device 101 of the inkjet printing device 100 can thus be configured to insert, in a first interval 321 which directly follows the first dot 301, one or more cyclical and/or print image-independent pre-ejection pulse phase 314 between a first dot 301 and a second dot 308 that are printed by the same nozzle 21, 22, and to insert a print image-dependent pre-ejection pulse 304 in a subsequent second interval 322 that is arranged directly before the rest phase 303 for the second dot 308. A drying out of ink can thus be particularly efficiently and reliably avoided in order to enable an optimally high print quality of the inkjet printing device 100.

As was already presented further above, the drying up of ink can be counteracted, possibly in addition to one or more refresh measures, via the insertion of print image-dependent pre-ejection pulse phases 304. Depending on [an? the?] interval 309, 309′ of two print dots 301, 308, a defined amount of pre-fire actuations, i.e. pre-fire pulses, is thereby implemented before a print dot 308, followed by a relatively short rest phase 303 before the fire pulse for the print dot 308. These actuations, i.e. these pulses, keep the ink in the nozzles 21, 22 in motion, but without applying ink to the paper.

The hardware of the printing device 100 can have a technical limitation that leads to the situation that the sum of the maximum possible number of pre-fire actuations, or of the maximum possible phase duration, and the duration of the rest phase (i.e. the duration 306) must be less than the first threshold 302 as of which a pre-fire pulse phase 304 is inserted. The first threshold 302, i.e. the value of the first threshold 302, is typically determined by the drying behavior of the ink. Given a relatively fast-drying ink, the first threshold 302 is relatively small, such that the maximum possible duration of the pre-fire pulse phase 304 is relatively brief and the maximum possible count of pre-fire pulses is relatively low. It may also be difficult to determine matching pre-fire pulses which are simultaneously applicable to relatively short and relatively long print dot intervals.

As described in this document, one or more “cyclical pre-fire” phases 314 can be inserted if pre-fire actuations are required but, due to the aforementioned technical limitation, it is not possible to insert a print image-dependent pre-fire pulse phase 304. The cyclical pre-fire can be activated as of a defined print dot interval, in particular as of the second threshold 312. In contrast to the print image-dependent pre-fire, continuous pre-fire actuations are thereby not activated singly. Instead, x successive pre-fire actuations, followed by y clock cycles of pause, are implemented periodically. x and/or y can thereby have been established in advance. Via one or more “cyclical pre-fire” phases 314, the ink is kept in motion in longer ranges without print dots.

The cyclical pre-fire can be applied until a print dot 308 is newly detected in the print image. In this event, an image-dependent pre-fire phase 304 can be inserted.

An image-dependent pre-fire phase 304 can thus be applied, limited to relatively small print dot intervals 309, 309′. Given relatively large print dot intervals 309, 309′, one or more cyclical pre-fire pulses 314 can initially be inserted. An improved refresh of the ink being used can thus be achieved in all print modes and print dot intervals. A high print quality can be ensured via the combination of the two pre-fire phases 304, 314 for different page lengths, for example 3-60 inches.

A (control) device 101 is thus described for controlling the printing of a print image by means of at least one nozzle 21, 22 of an inkjet printing device 100. The device 101 is typically configured to execute the measures described in this document for every single nozzle 21, 22 of a plurality of nozzles 21, 22 of the printing device 100. The different nozzles 21, 22 can thereby be associated, in a one-to-one relationship, with different columns 31, 32 of the print image to be printed. Respective dots 301, 308 can be printed in different lines of the print image by the individual nozzles 21, 22.

The device 101 can be configured to determine—for example, at a defined checkpoint in time and/or at a defined check line of the print image—the interval 309, 309′ until the printing of a following dot 308 by means of a nozzle 21, 22. The interval 309, 309′ can indicate the number of lines and/or the duration until the printing of the next dots 308 by the nozzle 21, 22. The interval 309, 309′ can be determined on the basis of the print data for the print image to be printed. The precise value of the interval 309, 309′ can thereby possibly be determined, for example if the interval 309, 309′ is less than or equal to the (possibly second) interval threshold 312. On the other hand, only a lower limit value of the interval 309, 309′ can possibly be determined, for example if the interval 309, 309′ is greater than the (possibly second) interval threshold 312.

The device 101 can be configured to effect a print image-dependent pre-ejection pulse phase 304 by means of the nozzle 21, 22 if the interval 309, 309′ is less than or equal to a predefined interval threshold 312 that, in this document, is also referred to as a second interval threshold. One or more parameters, for example the duration 307 and/or the number of pre-ejection pulses, of the print image-dependent pre-ejection pulse phase 304 can thereby be dependent on the determined interval 109. The device 101 can also be configured to effect at least one print image-independent pre-ejection pulse phase 314 by means of the nozzle 21, 22 if the interval 309, 309′ is greater than or equal to the interval threshold 312. The one or more corresponding parameters, for example the duration 317 and/or the number of pre-ejection pulses, of the print image-independent pre-ejection pulse phase 314 can be independent of the determined interval 309, 309′.

The device 101 can in particular be configured to effect one or more print image-independent pre-ejection pulse phases 314 by means of the nozzle 21, 22 in a first interval 321 that directly follows the first dot 301, between a first dot 301 and a directly following second dot 308 of the print image that are printed by means of the same nozzle 21, 22. The device 101 can also be configured to effect the print image-dependent pre-ejection pulse phase 304 by means of the nozzle 21, 22 in a second interval 322 following the first interval 321, which second interval 322 is arranged directly before the rest phase 303 for printing the second dot 308.

In other words, a device 101 is described for controlling the printing of a print image by means of at least one nozzle 21, 22 of an inkjet printing device 100 that is configured to —given the presence of a relatively long printing pause of the nozzle 21, 22—insert one or more print image-independent pre-ejection pulse phases 314, followed by a print image-dependent pre-ejection pulse phase 304, between the printing of two directly successive dots 301, 308, in order to efficiently and reliably increase the print quality of the printing device 100.

Furthermore, an inkjet printing device 100 is described that comprises the (control) device 101 described in this document.

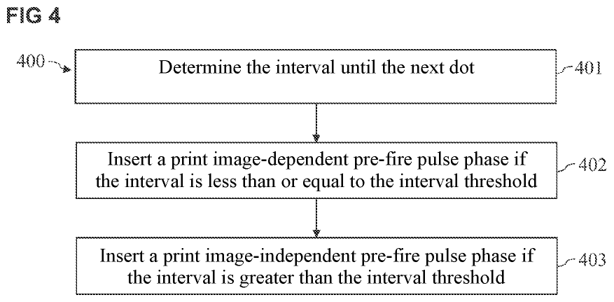

FIG. 4 shows a workflow diagram of a (possibly computer-implemented) method 400 for inserting one or more pre-ejection pulses upon printing a print image by means of a nozzle 21, 22 of an inkjet printing device 100. The inkjet printing device 100 can comprise a plurality of nozzles 21, 22 for printing dots 301, 308 in a corresponding plurality of columns 31, 32 of the print image. A defined nozzle 21, 22 for a defined column 31, 32 can thereby be designed to print dots 301, 308 in different lines of the defined column 31, 32. Dots 301, 308 can thus be printed line by line by a nozzle 21, 22 within a column 31, 32 of the print image.

The method 400 comprises, in particular for a defined nozzle 21, 22, the determination 401 of the interval 309, 309′ until the printing of a subsequent dot 308 by means of the nozzle 21, 22. The interval 309, 309′ until the printing of the following dot 308 by means of the nozzle 21, 22 can thereby indicate the number of lines in which no dots are printed by the nozzle 21, 22 directly before the following dot 308. The interval 309, 309′ can thus indicate the duration, measured in the number of lines, of the pending printing pause of the nozzle 21, 22. The interval 309, 309′ can be determined on the basis of the print data for the print image to be printed.

Furthermore, the method 400 comprises effecting 402 a print image-dependent pre-ejection pulse phase 404 by means of the nozzle 21, 22 if the interval 309, 309′ is less than or equal to a predefined interval threshold 312 which, in this document, is also referred to as the second interval threshold. One or more parameters of the print image-dependent pre-ejection pulse phase 304 can thereby be dependent on the determined interval 309, 309′. The one or more parameters of the print image-dependent pre-ejection pulse phase 304 can comprise: the duration 307 of the print image-dependent pre-ejection pulse phase 304; the number of pre-ejection pulses within the print image-dependent pre-ejection pulse phase 304; the amplitude of a pre-ejection pulse of the print image-dependent pre-ejection pulse phase 304 and/or the waveform of a pre-ejection pulse of the print image-dependent pre-ejection pulse phase 304.

The method 400 can in particular comprise establishing the duration 307 of the print image-dependent pre-ejection pulse phase 304 and/or the number of pre-ejection pulses within the print image-dependent pre-ejection pulse phase 304, depending on the determined interval 309, 309′ until the printing of the following dot 308 by means of the nozzle 21, 22. Considered very generally, the drying time of the ink has a strong influence on the duration 307.

Furthermore, the method 400 comprises effecting 403 a print image-independent pre-ejection pulse phase 314 by means of the nozzle 21, 22 if the interval 309, 309′ is greater than the interval threshold 312. The one or more corresponding parameters of the print image-independent pre-ejection pulse phase 314 which correspond to the one or more interval-dependent parameters of the print image-dependent pre-ejection pulse phase 304 can thereby be independent of the determined interval 309, 309′. The one or more parameters of the print image-independent pre-ejection pulse phase 314 may comprise: the duration 317 of the print image-independent pre-ejection pulse phase 314; the number of pre-ejection pulses within the print image-independent pre-ejection pulse phase 314; the amplitude of a pre-ejection pulse of the print image-independent pre-ejection pulse phase 314; and/or the waveform of a pre-ejection pulse of the print image-independent pre-ejection pulse phase 314. The parameter values of the one or more parameters of the print image-independent pre-ejection pulse phase 314 can, for example, have been established in advance of the printing of the print image.

Via the combined use of a print image-independent pre-ejection pulse phase 314 and of a print image-dependent pre-ejection pulse phase 304, the print quality of the printing device 100 can be efficiently and reliably increased, in particular given use of a relatively fast-drying ink.

The method 400 may comprise the repeated checking, at a sequence of checkpoints in time and/or at a sequence of check lines of the print image, whether the respective interval 309, 309′ until the printing of the following dot 308 by means of the nozzle 21, 22 continues to be greater than the interval threshold 312. A respective print image-independent pre-ejection pulse phase 314 can then be effected as long as it is determined that the respective interval 309, 309′ until the printing of the following dot 308 by means of the nozzle 21, 22 is greater than the interval threshold 312.

On the other hand, the method 400 may comprise effecting the print image-dependent pre-ejection pulse phase 304 by means of the nozzle 21, 22 if, for a checkpoint in time and/or for a check line, it is determined that the interval 309, 309′ until the printing of the following dot 308 by means of the nozzle 21, 22 is less than or equal to the interval threshold 312.

A repeated, in particular cyclical, effecting of print image-independent pre-ejection pulse phases 314 by means of the nozzle 21, 22 can thus be effected as long as the interval 309, 309′ until the printing of the following 38 by means of the nozzle 21, 22 is greater than the interval threshold 312. On the other hand, a print image-dependent pre-ejection pulse phase 304 can be effected as soon as the interval 309, 309′ corresponds to or falls below the interval threshold 312. The print quality can be especially increased via such a combination of a sequence of print image-independent pre-ejection pulse phases 314 and a subsequent print image-dependent pre-ejection pulse phase 304.

The method 400 described in this document can be executed for each nozzle 21, 22 of the plurality of nozzles 21, 22 of the inkjet printing device 100. Alternatively or additionally, the method 400 can be repeated cyclically at the sequence of checkpoints in time and/or at the sequence of check lines of the print image. Directly successive checkpoints in time and/or directly successive check lines can thereby be spaced apart from one another corresponding to a predefined cycle duration 313. The cycle duration 313 can, for example, correspond to 500 lines or more, or 1000 lines or more, or 4000 lines or more. A high print quality can be lastingly provided via the repeated checking.

In one example, a print image-independent pre-ejection pulse phase 314 can comprise N pre-ejection pulses in corresponding N lines of the print image to be printed. M lines of the print image to be printed in which no pulses are effected can follow the print image-independent pre-ejection pulse phase 314. The cycle duration 313 can thus correspond to N+M lines. The number N of pre-ejection pulses can, for example, be between 50 and 150, and/or the number M of lines without pulses can, for example, be between 3500 and 4500.

If, after effecting and/or inserting one or more print image-independent pre-ejection pulses 314, it is detected that the interval 309, 309′ is less than or equal to the interval threshold 312, a print image-dependent pre-ejection pulse phase 304 can be effected and/or inserted. As has already been presented further above, a parameter—in particular the number of pre-ejection pulses—of the print image-dependent pre-ejection pulse phase 304 can be dependent on the value of the interval 309, 309′. The value of the parameter—in particular the number of pre-ejection pulses—can thereby be increased with increasing value of the interval 309, 309′. For example, this can take place stepwise in L different stages, wherein L is, for example, between 5 and 15. In a minimum stage a minimum number of pre-ejection pulses can be effected, and in a maximum stage a maximum number of pre-ejection pulses can be effected. Within the scope of the method 400, it can be effected that a print image-dependent pre-ejection pulse phase 304 in the maximum stage, in particular with the maximum number of pre-ejection pulses, is inserted and/or effected following one or more print image-independent pre-ejection pulse phases 314.

On the other hand, if it is detected that the interval 309, 309′ is less than or equal to the interval threshold 312 without one or more print image-independent pre-ejection pulse phases 314 having been previously inserted or effected, the interval 309, 309′ can thus be compared with the first interval threshold 302 in order to determine whether a print image-dependent pre-ejection pulse phase 304 is inserted or not. If the interval 309, 309′ is greater than the first interval threshold 302, it can be determined that a print image-dependent pre-ejection pulse phase 304 is inserted. The value of one or more parameters of the print image-dependent pre-ejection pulse phase 304 can also be determined depending on the value of the interval 309, 309′. In particular, the stage of the print image-dependent pre-ejection pulse phase 304 can be determined. The print image-dependent pre-ejection pulse phase 304 can then be inserted and/or effected with the determined parameter values for the one or more parameter. The print quality can thus be especially increased.

It is to be noted that, even if the large interval 309′ between two dots 308 generated by a nozzle 21, 22 is greater than the interval threshold 312, at least one print image-dependent pre-ejection pulse phase 304 can be effected within the interval threshold 312. After the interval threshold 312, at least one print image-independent pre-ejection pulse phase 314 can then be effected as in instances D through G in FIG. 3b.

### REFERENCE LIST

1 transport direction
21, 22 nozzle (print image)
31, 32 column (of the print image)
100 printing device
101 control unit/control device
102 print bar
103 print head
120 recording medium
140 print group
150 fixing or drying unit
201 nozzle opening
202 wall
210 meniscus
212 nozzle chamber
220 actuator
221, 222 deflection (actuator)
301, 308 dot or print dot
302 first interval threshold
303 rest phase
304 print image-dependent pre-ejection pulse phase
305 missing portion of a print image-dependent pre-ejection pulse phase
306 maximum possible, cumulative, duration of print image-dependent pre-ejection pulse phase and rest phase
307 duration of the print image-dependent pre-ejection pulse phase
309, 309′ interval between directly successive dots
310 printing direction
311 interval between two directly successive print image-independent and/or cyclical pre-ejection pulse phases
312 (second) interval threshold
313 cycle duration
314 print image-independent and/or cyclical pre-ejection pulse phase
317 duration of the print image-independent and/or cyclical pre-ejection pulse phase
321 first interval (between two directly successive dots)
322 second interval (between two directly successive dots)
400 method for inserting pre-fire pulses
401-403 method steps

1. A method for inserting one or more pre-ejection pulses upon printing a print image with a nozzle of an inkjet printing device, the method comprising:
determining an interval until a printing of a following dot with the nozzle;
effecting at least one print image-dependent pre-ejection pulse phase with the nozzle if the interval is smaller than or a same size as an interval threshold, where one or more parameters of the print image-dependent pre-ejection pulse phase are dependent on the determined interval; and/or
effecting at least one print image-independent pre-ejection pulse phase with the nozzle if the interval is greater than the interval threshold.

2. The method according to claim 1, wherein one or more parameters of the print image-independent pre-ejection pulse phase are independent of the determined interval.

3. The method according to claim 1, further comprising:
effecting at least one print image-dependent pre-ejection pulse phase with the nozzle within the interval threshold and before the print image-independent pre-ejection pulse phase if the interval is greater than the interval threshold.

4. The method according to claim 1, wherein the print image-independent pre-ejection pulse phase is effected after the interval threshold.

5. The method according to claim 1, wherein the one or more parameters of the print image-dependent pre-ejection pulse phase and the print image-independent pre-ejection pulse phase comprise
a duration of the print image-dependent pre-ejection pulse phase and a duration of the part image-independent pre-ejection pulse phase;
a number of pre-ejection pulses within the print image-dependent pre-ejection pulse phase and a number of pre-ejection pulse within the print image-independent pre-ejection pulse phase;
an amplitude of a pre-ejection pulse of the print image-dependent pre-ejection pulse phase and an amplitude of a pre-ejection pulse of the print image-independent pre-ejection pulse phase; and/or
a workflow of a pre-ejection pulse of the print image-dependent pre-ejection pulse phase and a workflow of a pre-ejection pulse of the print image-independent pre-ejection pulse phase.

6. The method according to claim 1, further comprising
repeatedly checking, at a sequence of checkpoints in time and/or at a sequence of check lines of the print image, whether the respective interval until the printing of the following dot with the nozzle continues to be greater than the interval threshold; and
effecting a respective print image-independent pre-ejection pulse phase as long as it is determined that the respective interval until the printing of the following dot by with the nozzle is greater than the interval threshold.

7. The method according to claim 1, further comprising, if it is determined for a checkpoint in time and/or for a check line of the print image that the interval is less than or equal to the interval threshold the print image-dependent pre-ejection pulse phase is effected with the nozzle.

8. The method according to claim 1, further comprising repeatedly effecting print image-independent pre-ejection pulse phases with the nozzle as long as the interval until the printing of the following dot with the nozzle is greater than the interval threshold.

9. The method according to claim 1, wherein
the method comprises establishing a duration of the print image-dependent pre-ejection pulse phase and/or a number of pre-ejection pulses within the print image-dependent pre-ejection pulse phase, depending on the interval until the printing of the following dot with the nozzle; and/or
the duration of the print image-independent pre-ejection pulse phase and/or the number of pre-ejection pulses within the print image-independent pre-ejection pulse phase have been established in advance of the printing of the print image.

10. The method according to claim 1, wherein
the inkjet printing device comprises a plurality of nozzles for printing dots in a corresponding plurality of columns of the print image;
a defined nozzle for a defined column is designed to print dots in different lines of the defined column of the print image;
the interval until the printing of the following dot with the defined nozzle indicates a number of lines in which no dots are printed directly before the following dot by the defined nozzle; and
the method is executed for every nozzle of the plurality of nozzles.

11. The method according to claim 1, wherein
the method is repeated cyclically at a sequence of checkpoints in time and/or at a sequence of check lines of the print image; and
directly successive checkpoints in time and/or directly successive check lines are spaced apart from one another corresponding to a cycle duration.

12. A device for controlling the printing of a print image with a nozzle of an inkjet printing device; wherein the device is configured
to determine an interval until the printing of a following dot with the nozzle;
to effect at least one print image-dependent pre-ejection pulse phase with the nozzle if the interval is smaller than or the same size as an interval threshold, where one or more parameters of the print image-dependent pre-ejection pulse phase are dependent on the determined interval and/or
to effect at least one print image-independent pre-ejection pulse phase with the nozzle the interval is greater than the interval threshold.

13. The device according to claim 12, wherein at least one print image-dependent pre-ejection pulse phase is to be effected with the nozzle within the interval threshold and before the print image-independent pre-ejection pulse phase if the interval is greater than the interval threshold.

14. A device according to claim 12, wherein at least one print image-independent pre-ejection pulse phase is to be effected with the nozzle after the interval threshold.

15. The device according to claim 12, wherein the device is configured to effect, between a first dot and a directly following second dot of the print image that are printed with the nozzle,
one or more print image-independent pre-ejection pulse phases with the nozzle in a first interval that directly follows the first dot; and
the print image-dependent pre-ejection pulse phase with the nozzle in a subsequent second interval that is arranged directly before a rest phase for printing the second dot.
